(19) United States
(12) Patent Application Publication
(10) Pub. No.: US 2006/0033844 A1
(43) Pub. Date: Feb. 16, 2006

(54) Image sharpness improvement apparatus based on human visual system and method thereof

(75) Inventor: Su Jin Park, Seoul (KR)

Correspondence Address: JONATHAN Y. KANG, ESQ.;LEE, HONG, DEGERMAN, KANG & SCHMADEKA, 14th Floor, 801 S. Figueroa Street, Los Angeles, CA, 90017, US

(73) Assignee: LG Electronics Inc.

(21) Appl. No.: 11/201,228

(22) Filed: Aug. 9, 2005

(30) Foreign Application Priority Data
Aug. 11, 2004 (KR) 2004-063239

(51) Int. Cl. G06K 9/40

(52) U.S. Cl. 348/626; 382/266

(57) ABSTRACT

An image sharpness improvement apparatus based on human visual system and a method thereof adapted to improve sharpness of images by utilizing a JND characteristic which is one of the features a human visual system possesses, wherein a luminance change signal is extracted by high-pass filtering an input luminance signal, a sharpness parameter extractor extracting a sharpness parameter in response to the input luminance signal and the luminance change signal, and a sharpness adjustor adjusting the sharpness of the input luminance signal in response to the luminance change signal and the sharpness parameter to output an output luminance signal, such that images can be improved to an optimum sharpness noticeable by a human.

### CROSS REFERENCE TO RELATED APPLICATIONS

Pursuant to 35 U.S.C. § 119(a), this application claims the benefit of earlier filing date and right of priority to Korean Patent Application No. 10-2004-0063239, filed on Aug. 11, 2004, the content of which is hereby incorporated by reference herein in its entirety.

### BACKGROUND OF THE INVENION

1. Field of the invention

The present invention relates to an image sharpness improvement apparatus based on human visual system and a method thereof adapted to use a characteristic of Just Noticeable Difference (JND) which is one of the characteristics human visual system has to improve sharpness of images.

2. Description of the Prior Art

Display panels made of new material such as Liquid Crystal Display (LCD) and Plasma Display Panel (PDP) are used for television sets and monitors. Concomitant with the development of apparatus for improving the image quality displayed on a display panel, development of software thereto is also being run abreast with at the same time. One of the methods to improve the image quality is a well known image sharpening technique named unsharp masking method.

The unsharp masking method is such that minute parts of images are further undertaken and contrast effect relative to image edges is heightened to enable to display images much sharper even for dimmed images.

FIG. 1 is a graph explaining a method for improving the sharpness of images according to the conventional unsharp masking method.

The unsharp masking method thus illustrated is such that an image area relatively low in luminance about a reference level in an image border area is adjusted to a much lower luminance, while an image area relatively higher in luminance is adjusted to much higher luminance to make the border area stand out.

In other words, the unsharp masking method based on the concept mentioned above is to make a bright area further brightened, and to make a dimmed area much dimmer, enabling a contrast between light and brightness to stand out and a contour line to be displayed distinctively for easy discrimination of images.

However, the conventional unsharp masking method thus described can be applied to a case where a parameter set-up to which sharpness is applied is passive, and can be applied to all pixels of images. As a result, there is a problem in reflecting the only features of local images. There is another problem in that an application to products is in reality inadequate as the parameter set-up is a result obtainable through countless experiments.

### SUMMARY OF THE INVENTION

The object of the present invention is to provide an image sharpness improvement apparatus based on human visual system and a method thereof adapted to apply a Just Noticeable Difference (JND) which is a feature of a human visual system to thereby improve sharpness of images.

Accordance with the object of the present invention, there is provided an image sharpness improvement apparatus based on human visual system, the apparatus comprising: a high pass filter for high-pass filtering an input luminance signal to extract a luminance change signal; a sharpness parameter extractor for extracting a sharpness parameter in response to the inputted luminance signal and the luminance change signal; and a sharpness adjustor for adjusting the sharpness of the inputted luminance signal in response to the luminance change signal and the sharpness parameter to output an output luminance signal.

The high pass filer extracts a luminance change signal by multiplication of the input luminance signal by a predetermined filter coefficient.

The luminance change signal is extracted in such a manner that a plurality of filter coefficients predetermined at each input luminance signal of a plurality of pixels positioned within N×N mask about relevant pixels of the input luminance signals are respectively multiplied and added up.

The filter coefficient is any one of the filter coefficients out of coefficient of Betterworth filter, coefficient of Chebyshev filter and coefficient of Wiener filter.

The sharpness parameter extractor calculates a JND value relative to the input luminance signal, the calculated JND value and the size of the luminance change signal are compared therebetween, and extracts a sharpness parameter in response to the compared result.

The sharpness parameter sets a temporary sharpness parameter as 0 when the size of the input luminance signal is less than the JND value, and calculates the temporary sharpness parameter by a predetermined Expression when the size of the input luminance signal is not less than the JND value, and then calculates the sharpness parameter by a predetermined Expression.

The sharpness adjustor is disposed with a manual mode in which an output luminance signal is adjustable by a user, and an automatic mode determined in response to a predetermined setup.

### BRIEF DESCRIPTION OF THE DRAWINGS

Examples of the invention will now be described in relation to the accompanying drawings wherein:

FIG. 1 is a graph illustrating a method for improving sharpness of images according to the conventional unsharp masking method;

FIG. 2 is a block diagram illustrating a construction of an image sharpness improvement apparatus according to the present invention;

FIG. 3 is a signal flow chart illustrating a process for extracting a sharpness parameter according to the present invention;

FIG. 4 is a graph illustrating a relation between a temporary sharpness parameter and a luminance change signal according to the present invention; and

FIG. 5 is a signal flow chart illustrating an image sharpness improvement method according to the present invention.

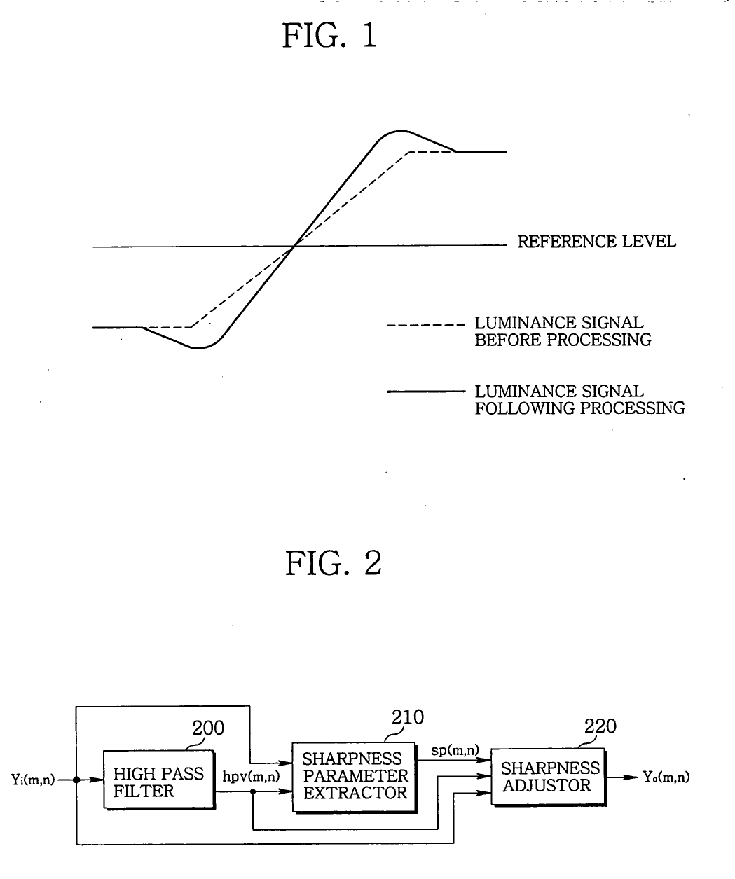

### DETAILED DESCRIPTION OF THE INVENTION

These and other objectives of the present invention will no doubt become obvious to those of ordinary skill in the art after reading the following detailed description of the preferred embodiment that is illustrated in FIGS. 2 to 5.

FIG. 2 is a block diagram illustrating a preferred embodiment of an image sharpness improvement apparatus according to the present invention, wherein the present invention can be applied to various color spaces, and in order to simplify the explanation, a course of processing Y signal in YUV signal will be given as an example.

Referring to FIG. 2, reference numeral 200 is a high pass filter. The high pass filter (200) serves to high-pass filter an input luminance signal Yi (m, n) to generate a luminance change signal hpv (m, n). The high pass filter (200) forms N×N mask about the input luminance signal Yi (m, n) and extracts pixels located within the N×N mask. The respectively extracted pixels are multiplied by a predetermined filter coefficient, which are all added up to generate a luminance change signal hpv (m, n).

For example, the high pass filter (200) forms a 3×3 mask to extract a luminance signal of each pixel as shown in Table 1 about the input luminance signal Yi (m, n).

TABLE 1

| | | |
|---|---|---|
| Yi (m − 1, n − 1) | Yi (m, n − 1) | Yi (m + 1, n − 1) |
| Yi (m − 1, n) | Yi (m, n) | Yi (m + 1, n) |
| Yi (m − 1, n + 1) | Yi (m, n + 1) | Yi (m + 1, n + 1) |

And, for example, filter coefficients are pre-set as shown in Table 2.

TABLE 2

| | | |
|---|---|---|
| coeff (0,0) | coeff (1,0) | coeff (2,0) |
| coeff (0,1) | coeff (1,1) | coeff (2,1) |
| coeff (0,2) | coeff (1,2) | Coeff (2,2) |

Where, for example, the filter coefficients use coefficients of Butteworth filter, Chebyshev filter, or Wiener filter.

Luminance signals for each pixel thus extracted are multiplied by filter coefficients as in Expression 1, and added up to generate a luminance change signal hpv (m, n)
hpv(m, n)=[Yi(m−1, n−1)×coeff(0, 0)]+[Yi(m, n−1)×
coeff(1, 0)]+[Yi(m−1, n−1)×coeff(2, 0)]+[Yi(m−1, n)×coeff(0, 1)]+[Yi(m, n)×coeff(1, 1)]+[Yi(m+1,n)×coeff(2, 1)]+[Yi(m−1, n+1)×coeff(0, 2)]+[Yi(m, n+1)×coeff(1, 2)]+[Yi(m+1, n+1)×coeff(2, 2)] [Expression 1]

Reference numeral 210 is a sharpness parameter extractor. The sharpness parameter extractor uses the input luminance signal Yi (m, n) and the luminance change signal hpv (m, n) outputted from the high pass filter (200) to generate a sharpness parameter sp (m, n).

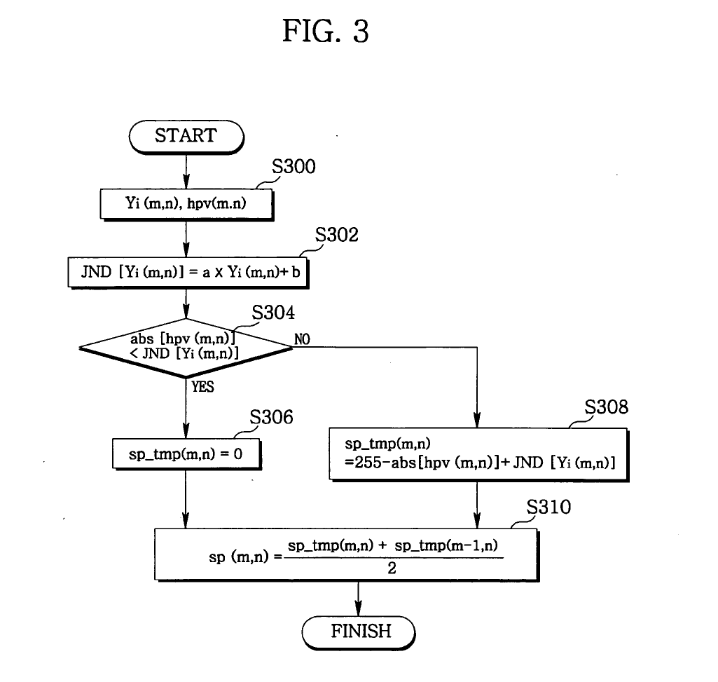

FIG. 3 is a signal flow chart illustrating a process of the sharpness parameter extractor (210) extracting a sharpness parameter according to the present invention. Referring to FIG. 3, the sharpness parameter extractor (210) inputs the input luminance signal Yi (m, n) and a luminance change signal hpv (m, n) (S300). The input luminance signal Yi (m, n) is utilized to calculate a JND value Yi [(m, n)] as shown in Expression 2 (S302).
JND [Yi(m, n)]=a×Yi(m, n)+b [Expression 2]

Where, a and b are constants, a is 0.4, while b is 0.12301.

When the JND value [Yi(m, n)] is calculated, the size abs[hpv(m, n)] of the luminance change signal hpv(m, n) is compared with the JND value JND[Yi(m, n)] (S304).

As a result of the comparison, if abs[hpv(m, n)]<JND[Yi(m, n)], a value of a temporary sharpness parameter sp_tmp(m, n) is determined as 0 (S306). If it is not discriminated that abs[hpv(m, n)]<JND[Yi(m, n)] the value of the temporary sharpness parameter sp_tmp(m, n) is calculated from Expression 3 (S308).
sp_{—}tmp(m, n)=255−abs[hpv(m, n)]+JND[Yi(m, n)] [Expression 3]

When the temporary sharpness parameter is deteremined, a sharpness parameter sp(m, n) is calculated from Expression 4 (S310).
sp(m, n)=[sp_{—}tmp(m, n)+sp_{—}tmp(m−1, n)]÷2 [Expression 4]

The feature of the sharpness parameter is to utilize a characteristic of JND, which is one of the characteristics a Human Visual System (HVS) has. The JND is a minimum value noticeable of a difference between two stimuli, and in the present invention, denotes an amount of luminance change a human can distinguish.

In the present invention, the sharpness parameter extractor (210) uses the Expression 2 to obtain a JND value JND [Yi(m, n)] of the input luminance signal Yi(m, n). The JND value thus obtained JND [Yi(m, n)] and the size of the luminance change signal abs[hpv(m, n)] are compared therebetween. As a result of the comparison, if abs[hpv(m, n)]<JND[Yi(m, n)], it is a luminance change which cannot be noticed by a human. For that reason, the value of the temporary sharpness parameter sp_tmp(m, n) is determined as 0.

If it is not discriminated that abs[hpv(m, n)]<JND[Yi(m, n)], it is a luminance change a human can notice. Now, a value of temporary sharpness parameter sp_tmp(m, n) in inverse proportion to the size of the luminance change signal [hpv(m, n)] is calculated from the Expression 3.

When the value of the temporary sharpness parameter sp_tmp(m, n) is calculated, the sharpness parameter sp(m, n) is calculated. It can be noticed that the value of the sharpness parameter sp(m, n) is a parameter that is diminishing as the size of the luminance change signal goes larger with the value of JND being at threshold value.

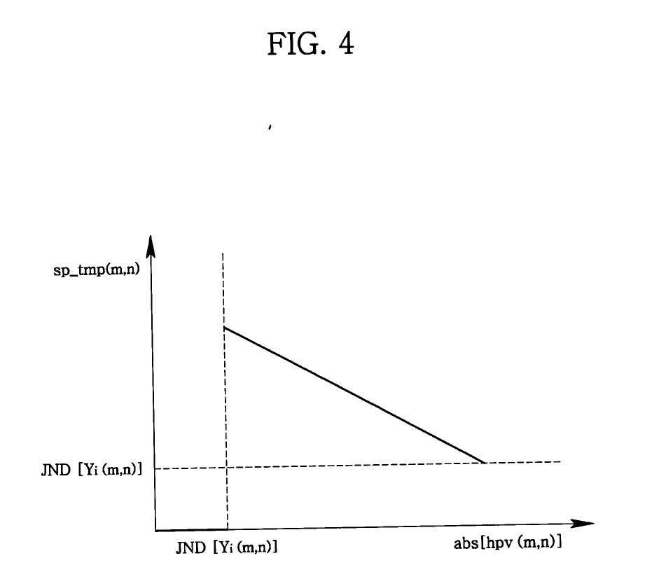

FIG. 4 is a graph illustrating a relation between a temporary sharpness parameter and a luminance change signal according to the present invention, where x axis is the size of the luminance change signal abs[hpv(m, n)] and Y axis is the temporary sharpness parameter sp_tmp(m, n). If the size of the luminance change signal abs[hpv(m, n)] is smaller than the JND value JND[Yi(m, n)] noticeable by a human, the value of the temporary sharpness parameter sp_tmp(m, n) is 0, such that the sharpness parameter sp(m, n) is to have a minimum value. If the size of the luminance change signal abs[hpv(m, n)] is the same as the JND value JND[Yi(m, n)], the temporary sharpness parameter sp_tmp(m, n) is to have the maximum value, and as the size of the luminance change signal abs[hpv(m, n)] increases, the temporary sharpness parameter is reduced to the JND value JND[Yi(m, n)]. It can noticed that the size of the luminance change signal abs[hpv(m, n)] increases, the sharpness parameter sp(m, n) is reduced.

In other words, there is an advantage in the present invention in that a temporary sharpness parameter is not increased relative to the luminance change a human cannot notice to thereby improve a spontaneous sharpness. Furthermore, the amount of sharpness improvement is reduced as the size of the luminance change is increased relative to the luminance change noticeable by a human to thereby prevent an artificial distortion phenomenon.

Reference numeral 220 is a sharpness adjustor adjusts a sharpness of the input luminance signal Yi (m, n) to generate an output luminance signal Yo (m, n) in response to hpv (m, n) extracted by the high pass filter (200) and the sharpness parameter sp (m, n) extracted by the sharpness parameter extractor (210).

The sharpness adjustor (220) implements an operation, for example, as shown in Expression 5 to generate an output luminance signal Yo (m, n).
Yo(m, n)=Yi(m, n)+w×sp(m, n)×hpv(m, n), [Expression 5]

wherein w is a global parameter which can be adjusted by an automatic mode or a manual mode. The w is given as 0.5 as a default value in case of an automatic mode, and the w has a value between 0 to 1 and can be adjusted by a user in case of a manual mode.

The operation method thus described has a feature of automatically improving the sharpness in response to the local characteristic of images and manually adjusting an overall sharpness of images as well.

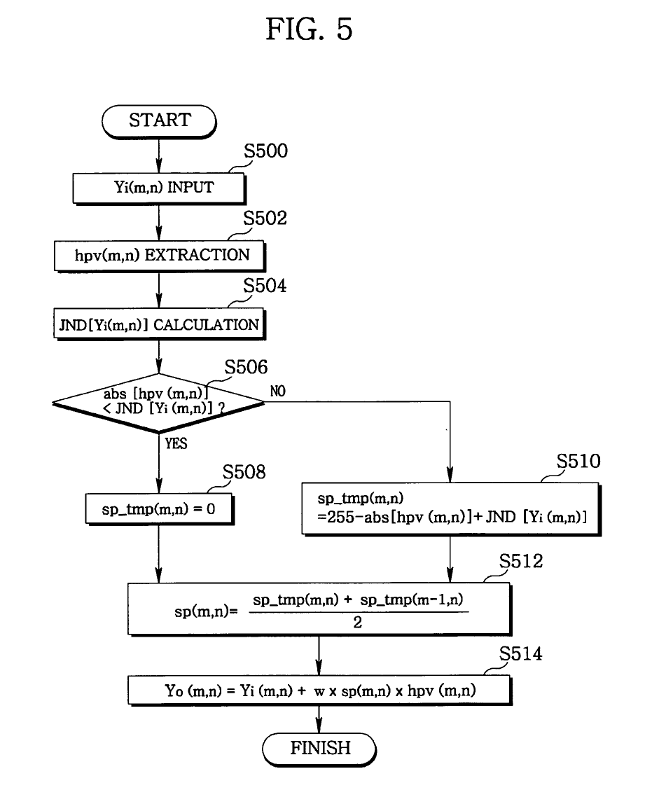

FIG. 5 is a signal flow chart illustrating an image sharpness improvement method according to the present invention.

Referring to FIG. 5, the high pass filter (200) inputs an input luminance signal Yi (m, n) (S500). The high pass filter (200) uses the input luminance signal Yi (m, n) thus inputted to calculate a luminance change signal hpv (m, n) as shown in Expression 1 (S502).

When the luminance change signal hpv (m, n) is calculated, the sharpness parameter extractor (210) uses the luminance change signal hpv (m, n) to calculate a JND value JND [Yi (m, n)] pursuant to Expression 2 (S504), and compares a JND value JND[Yi(m, n)] and the size of the luminance change signal abs[hpv(m, n)] (S506).

As a result of the comparison at S506, if abs[hpv(m, n)]<JND[Yi(m, n)], the sharpness parameter extractor (210) determines the value of the temporary sharpness parameter sp_tmp(m, n) as 0 (S508). As a result of the comparion at S506, if it is not discriminated that abs[hpv(m, n)]<JND[Yi(m, n)], the sharpness parameter extractor (210) calculates a value of temporary sharpness parameter sp_tmp(m, n) which is in inverse proportion to the size of the luminance change signal abs[hpv(m, n)] pursuant to Expression 3 (S510).

When the value of the temporary sharpness parameter sp_tmp(m, n) is calculated, the sharpness parameter extractor (210) calculates the value of the sharpness parameter sp(m, n) according to Expression 4 (S512).

Successively, the value of the sharpness parameter sp(m, n) thus calculated and the input luminance signal Yi (m, n) are used to calculate the output luminance signal Yo (m, n) as in Expression 5 (S514).

In other words, the present invention adjusts the sharpness when the size of the luminance change signal Yi (m, n) is larger than the JND value JND[Yi(m, n)], and the value of the sharpness parameter is made smaller as the size of the luminance change signal goes larger to naturally adjust the sharpness.

As apparent from the foregoing, the present invention uses a JND characteristic which is one of the features a human visual system possesses to improve the sharpness of images. Therefore, according to the present invention, images can be improved to an optimum sharpness noticeable by a human. Furthermore, the present invention can be simply embodied, and can be applied to image display apparatus and software to improve a deteriorated image sharpness.

What is claimed is:

1. An image sharpness improvement apparatus based on human visual system, the apparatus comprising: a high pass filter for high-pass filtering an input luminance signal to extract a luminance change signal; a sharpness parameter extractor for extracting a sharpness parameter in response to the input luminance signal and the luminance change signal; and a sharpness adjustor for adjusting the sharpness of the input luminance signal in response to the luminance change signal and the sharpness parameter to output an output luminance signal.

2. The apparatus as defined in claim 1, wherein the high pass filer extracts a luminance change signal by multiplication of the input luminance signal by a predetermined filter coefficient.

3. The apparatus as defined in claim 2, wherein the luminance change signal is extracted in such a manner that a plurality of filter coefficients predetermined at each input luminance signal of a plurality of pixels positioned within N×N mask about relevant pixels of the input luminance signals are respectively multiplied and added up.

4. The apparatus as defined in claim 3, wherein the filter coefficient is any one of the filter coefficients out of coefficients of Betterworth filter, Chebyshev filter and Wiener filter.

5. The apparatus as defined in claim 1, wherein the sharpness parameter extractor calculates a JND value relative to the input luminance signal, the calculated JND value and the size of the luminance change signal are compared therebetween, and extracts a sharpness parameter in response to the compared result.

6. The apparatus as defined in claim 5, wherein the sharpness parameter sets a temporary sharpness parameter as 0 when the size of the input luminance signal is less than the JND value, and calculates the temporary sharpness parameter by Expression 3 when the size of the input luminance signal is not less than the JND value, and then calculates the sharpness parameter by Expression 4, wherein Expression 3 is sp_tmp(m, n)=255−abs[hpv(m, n)]+JND[Yi(m, n)] and Expression 4 is sp(m, n)=[sp_tmp(m, n)+sp_tmp(m−1, n)]÷2, where, sp_tmp(m, n) and sp_tmp(m−1, n)] denote temporary sharpness parameters, m and n denote X axis and Y axis, abs[hpv(m, n) denotes the size of the luminance change signal, JND[Yi(m, n)] denotes a JND value, and sp(m, n) denotes a sharpness parameter.

7. The apparatus as defined in claim 1, wherein the sharpness adjustor is disposed with a manual mode in which an output luminance signal is adjustable by a user, and an automatic mode determined in response to a predetermined setup.

8. The apparatus as defined in claim 7, wherein the manual mode calculates the output luminance signal according to Expression 5, which is Yo(m, n)=Yi(m, n)+w×sp(m, n)×hpv(m, n), where w is a global parameter and has a value between 0 and 1 according to a user's establishment, Yo (m, n) is an output luminance signal, Yi (m, n) is an input luminance signal, sp (m, n) is a sharpness parameter and hpv (m, n) is a luminance change signal.

9. The apparatus as defined in claim 7, wherein the automatic mode calculates an output luminance signal according to Expression 5, which is Yo(m, n)=Yi(m, n)+w×sp(m, n)×hpv(m, n), where Yo (m, n) denotes an output luminance signal, Yi (m, n) denotes an input luminance signal, w denotes a global parameter of 0.5, sp( m, n) denotes a sharpness parameter, and hpv (m, n) is a luminance change signal.

10. An image sharpness improvement method based on human visual system, the method comprising the steps of: extracting a luminance change signal by high-pass filtering an input luminance signal; calculating a JND value of the luminance change signal; comparing the JND value thus calculated with the size of the luminance change signal to generate a sharpness parameter; and adjusting the value of the input luminance signal in response to the luminance change signal and the sharpness parameter to generate an output luminance signal.

11. The method as defined in claim 10, wherein the step of extracting the luminance change signal is implemented by multiplying the input luminance signal by a predetermined filter coefficient.

12. The method as defined in claim 10, wherein the step of extracting the luminance change signal is implemented in such a manner that a plurality of filter coefficients predetermined at each input luminance signal of a plurality of pixels positioned within N×N mask about relevant pixels of the input luminance signals are respectively multiplied and added up.

13. The method as defined in claim 12, wherein the filter coefficient is any one of the filter coefficients out of coefficients of Betterworth filter, Chebyshev filter and Wiener filter.

14. The method as defined in claim 10, wherein the step of generating the sharpness parameter is implemented in such a manner that a temporary sharpness parameter is set at 0 if the size of the input luminance signal is smaller than the JND value, and if the size of the input luminance signal is equal to or greater than the JND value, the temporary sharpness parameter is calculated by Expression 3, and then by Expression 4, wherein the Expression 3 is sp_tmp(m, n)=255−abs[hpv(m, n)]+JND[Yi(m, n)] and Expression 4 is sp(m, n)=[sp_tmp(m, n)+sp_tmp(m−1, n)]÷2, where, sp_tmp(m, n) and sp_tmp(m−1, n)] denote temporary sharpness parameters, m and n denote X axis and Y axis, abs[hpv(m, n) denotes the size of the luminance change signal, JND[Yi(m, n)] denotes a JND value, and sp(m, n) denotes a sharpness parameter.

15. The method as defined in claim 10, wherein the generation of the output luminance signal comprises: a manual mode adjustable by a user; and an automatic mode determined by a basic set-up.

16. The method as defined in claim 15, wherein the manual mode calculates an output luminance signal according to Expression 5, which is Yo(m, n)=Yi(m, n)+w×sp(m, n)×hpv(m, n), where w is a global parameter and has a value between 0 and 1 according to a user's establishment, Yo (m, n) is an output luminance signal, Yi (m, n) is an input luminance signal, sp (m, n) is a sharpness parameter and hpv (m, n) is a luminance change signal.

17. The method as defined in claim 15, wherein the automatic mode calculates an output luminance signal according to Expression 5, which is Yo(m, n)=Yi(m, n)+w×sp(m, n)×hpv(m, n), Yo (m, n) denotes an output luminance signal, Yi (m, n) denotes an input luminance signal, w is a global parameter of 0.5, sp(m, n) denotes a sharpness parameter, and hpv (m, n) denotes a luminance change signal.
